(19) United States
(12) Patent Application Publication
(10) Pub. No.: US 2010/0323726 A1
(43) Pub. Date: Dec. 23, 2010

(54) REPORTING METHOD FOR A DATA TRANSMISSION DEVICE

(76) Inventors: Ting-Yu WANG, Taipei (TW); Phone Lin, Taipei (TW); Huai-Lei Fu, Taipei (TW)

Correspondence Address: Muncy, Geissler, Olds & Lowe, PLLC, 4000 Legato Road, Suite 310, FAIRFAX, VA, 22033, US

(21) Appl. No.: 12/489,686

(22) Filed: Jun. 23, 2009

(51) Int. Cl. H04W 4/00

(52) U.S. Cl. 455/466

(57) ABSTRACT

A reporting method for a data transmission device within a sensing region that comprises at least one data transmission device(s) for receiving a sensed data from a sensor device, transmitting the sensed data to a server, and broadcasting a message. Furthermore, the data transmission device enters a listening state for receiving the sensed data from the sensor device. If the data transmission device does not receive the message from any of the other data transmission device(s), will enter a reporting state for transmitting the sensed data and broadcasting the message. In addition, the data transmission device enters a sleeping state, if a reporting counter equals to zero. Therefore, the power wastage of the data transmission devices can be reduced.

### BACKGROUND OF THE INVENTION

1. Technical Field

The present invention is related to a reporting method for a data transmission device, wherein only one data transmission device transmits sensed data at a time in a sensing region.

2. Description of the Prior Art

Referring to FIG. 1, what is shown is a diagram of the sensed data transmission system according to the prior art. The data transmission system 10 comprises a plurality of mobile phones 11, and a plurality of sensor devices 13, wherein the mobile phones 11 and the sensor devices 13 are located in the same sensing region 12.

The sensor devices 13 can be used to sense environmental information and transmit sensed data to the mobile phones 11. As the mobile phone 11 receives the sensed data from the sensor device 13, the mobile phone 11 can transmit the sensed data to a server 15. Therefore, the server 15 accomplishes the collection of the sensed data in the sensing region 12.

As there is a plurality of mobile phones 11 in the sensing region 12, all the mobile phones 11 may transmit the sensed data to the server 15 at the same time or within the same time slot. However, it is not necessary for all mobile phones 11 to transmit the sensed data at the same time because of the high similarity of the sensed data. If there are many mobile phones 11 transmitting the sensed data to the server 15 at the same time, it not only causes redundancy for the data transmission system 10, but also the power wastage of the mobile phone 11. Moreover, as the server 15 receives plurality of sensed data at the same time, the server 15 must perform an extra work of selecting one sensed data from said sensed data transmissions of different mobile phones 11 at the same time.

### SUMMARY OF THE INVENTION

It is a primary objective of the present invention to provide a reporting method for a data transmission device, wherein there is a plurality of data transmission devices in a sensing region, and where only one data transmission device enters the reporting state for transmitting sensed data to a server at a time.

It is a secondary objective of the present invention to provide a reporting method for a data transmission device, wherein the data transmission devices in the sensing region can enter a sleeping state, which in turn reduces the power wastage of the data transmission device.

It is another objective of the present invention to provide a reporting method for a data transmission device, wherein the data transmission device can broadcast a message to other data transmission devices in the sensing region, while the data transmission device transmits the sensed data to a server.

It is still another objective of the present invention to provide a reporting method for a data transmission device, wherein each data transmission device enters the reporting state from the listening state after different time slot, such that the data transmission devices in the same sensing region may not transmit the same or similar sensed data to the server at the same time.

According to the above objectives, a reporting method for a data transmission device within a sensing region, the sensing region has one or more data transmission devices for receiving a sensed data from a sensor device, transmitting the sensed data to a server, and broadcasting a message, the reporting method comprising the steps of: entering a listening state for receiving the sensed data from the sensor device; determining whether a message from another data transmission device is received during a time slot; entering a reporting state for transmitting the sensed data and broadcasting the message, if the message from another data transmission device is not received; determining whether a reporting counter equals zero; remaining at the reporting state, as the reporting counter is not equal to zero; and entering a sleeping state, as the reporting counter equals to zero.

According to the above objectives, the reporting method may simply comprising the steps of: entering a listening state for receiving the sensed data from the sensor device; entering a reporting state for transmitting the sensed data to the server, and broadcasting the message; and entering a sleeping state.

According to the above objectives, a computer-readable medium having stored thereon a set of instructions to translate instructions, the set of instructions, which when executed by a processor, cause the processor to perform a method comprising the steps of: receiving a first sensed data; transmitting the first sensed data and broadcasting a message after a first time slot and a random time slot; receiving a second sensed data; transmitting the second sensed data and broadcasting the message after a second time slot; receiving an nth sensed data; and transmitting the nth sensed data after an nth time slot.

The present invention can be best understood through the following description and accompanying drawings.

### BRIEF DESCRIPTION OF THE DRAWINGS

FIG. 1 is a diagram of the sensed data transmission system according to the prior art;

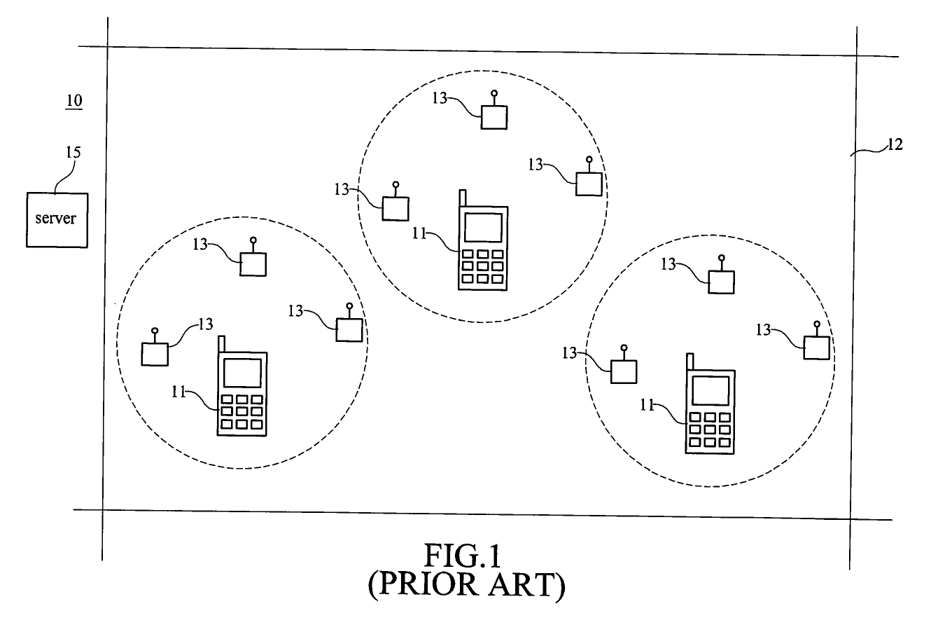

FIG. 2 is a schematic diagram of the sensed data transmission system according to an embodiment of the present invention;

FIG. 3 is a schematic diagram of the reporting method for the data transmission device according to an embodiment of the present invention;

FIG. 4 is a flowchart of the reporting method for said data transmission device according to an embodiment of the present invention;

FIG. 5 is a flowchart of the reporting method for said data transmission device according to an embodiment of the present invention; and

FIG. 6 is a schematic diagram of a storage medium storing a computer program for execution of a reporting method according to an embodiment of the present invention.

### DETAILED DESCRIPTION OF THE PREFERRED EMBODIMENTS

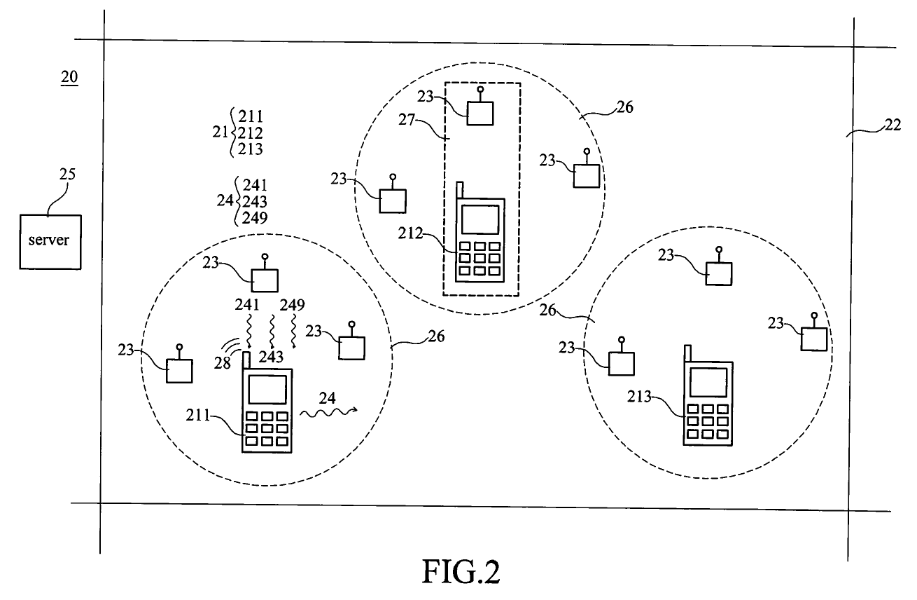

Referring to FIG. 2, a schematic diagram of the sensed data transmission system according to an embodiment of the present invention is disclosed. The data transmission system 20 comprises at least one data transmission device 21, and at least one sensor device 23, wherein the data transmission device 21 and the sensor devices 23 are located in a sensing region 22.

The sensor device 23 can be used to monitor the present environmental information, such as temperature, humidity, traffic, and so on, for generating a sensed data 24. Furthermore, the data transmission device 21 can receive the sensed data 24 from the sensor device 23 via a transmission line. In another embodiment of the invention, the sensed data 24 can be transmitted from the sensor device 23 to the data transmission device 21 in a transmission region 26 via a short-distance wireless mechanism, such as zigbee, RFID, Bluetooth and so on.

The data transmission device 21 can transmit the sensed data 24 that is transmitted from the sensor device 23 to a server 25. In one embodiment of the invention, the sensed data 24 can be transmitted from the data transmission device 21 to the server 25 via a wireless mechanism, such as GSM, CDMA, PHS and so on. The data transmission device 21 also broadcasts a message 28, as it transmits the sensed data 24 to the server 25, so that the other data transmission device 21 in the same sensing region 22 can receive the same message 28.

In one embodiment of the invention, the data transmission device 21 comprises a first data transmission device 211, a second data transmission device 212, and a third data transmission device 213. As the first data transmission device 211 transmits the sensed data 24 to the server 25, it will broadcast the message 28 to the second data transmission device 212 and the third data transmission device 213.

The second data transmission device 212 and the third data transmission device 213 do not transmit the same sensed data 24 or similar to the server 25 after they received the message 28 from the first data transmission device 211, such that there is, at the same time, only one data transmission device 21 (first data transmission device 211) in the same sensing region 22 to transmit the sensed data 24 to the server 25 at a time. Furthermore, the server 25 only receives one sensed data 24 at a time, and does not have the need to select one sensed data 24 from a plurality sensed data 24.

The data transmission device 21 can be a stationary device or a portable device, such as a mobile phone, PDA, notebook, and so on. In addition, the data transmission device 21 and the sensor device 23 can also be integrated into a data sensing transmission device 27.

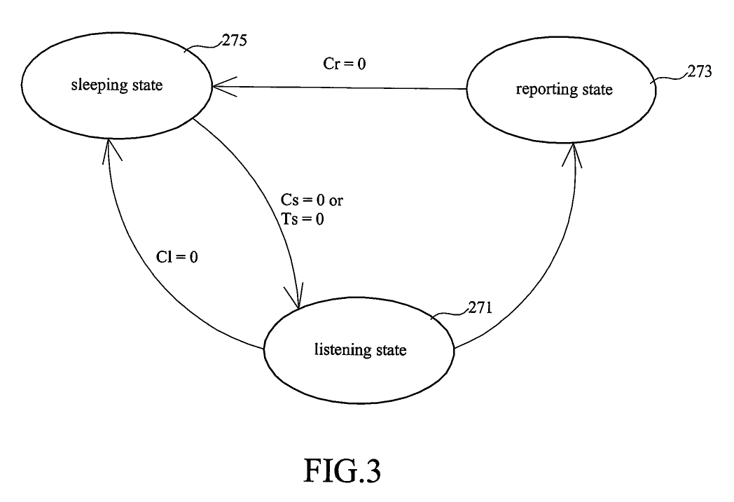

Referring to FIG. 3, a schematic diagram of the reporting method for the data transmission device according to an embodiment of the present invention is disclosed. Please, refer to FIG. 2 at the same time. The data transmission system 20 comprises a plurality of data transmission devices 21, and at least one sensor device 23. Moreover, the data transmission device 21 and the sensor devices 23 are located in the sensing region 22, and the data transmission device 21 can receive the sensed data 24 from at least one sensor device 23 and transmit the sensed data 24 to a server 25.

The data transmission devices 21 in the sensing region 22 can enter a listening state 271, a reporting state 273, or a sleeping state 275. The data transmission device 21 when at the listening state 271 can receive the sensed data 24 from the sensor device 23 within the transmission region 26, and, furthermore, the data transmission device 21 can also receive the message 28 from other data transmission devices 21 in the same sensing region 22. For example, the first data transmission device 211 can receive the message 28 from the second data transmission device 212 or the third data transmission device 213.

The data transmission device 21 enters the reporting state 273 from the listening state 271 for transmitting the sensed data 24 to the server 25. Moreover, the data transmission device 21 when at the reporting state 273 also broadcasts the message 28 to other data transmission devices 21 in the same sensing region 22, while it transmits the sensed data 24 to the server 25.

The data transmission device 21 can enter the sleeping state 275 from the listening state 271 or the reporting state 273. The data transmission device 21 at the sleeping state 275 cannot receive the sensed data 24 from the sensor device 23 or the message 28 from other data transmission devices 21. Furthermore, the data transmission device 21 at the sleeping state 275 also cannot transmit the sensed data 24 to the server 25 or broadcast the message 28 to other data transmission devices 21.

The state of the data transmission device 21 can be changed among the listening state 271, the reporting state 273, and the sleeping state 275. As the data transmission device 21 at the listening state 271 receives the sensed data 24 from the sensor device 23 and does not receive the message 28 from other data transmission devices 21, it will enter the reporting state 273 from the listening state 271 after a first time slot T1 and a random time slot Tr for transmitting the sensed data 24 and broadcasting the message 28. Moreover, the data transmission device 21 at the reporting state 273 can receive the sensed data 24 from the sensor device 23 continuously, and the data transmission device 21 will keep transmitting the sensed data 24 to the server 25.

The data transmission device 21 can enter the sleeping state 275 from the reporting state 273, after it has completed the transmission of the sensed data 24 one time or several times. For example, as the data transmission device 21 enters the reporting state 273, a reporting counter Cr can be initialized to count the times of transmission of the sensed data 24. When the reporting counter Cr is equal to zero, the data transmission device 21 enters the sleeping state 275 from the reporting state 273.

Moreover, the data transmission device 21 can also enter the sleeping state 275 from the listening state 271. For example, as the data transmission device 21 enters the listening state 271, a listening counter Cl can be initialized to count the times of receiving the sensed data 24 or the message 28. When the listening counter Cl is equal to zero, the data transmission device 21 enters the sleeping state 275 from the listening state 271.

In addition, the data transmission device 21 can enter the listening state 271 from the sleeping state 275. For example, as the data transmission device 21 enters the sleeping state 275, a sleeping counter Cs can be initialized to count. When the sleeping counter Cs is equal to zero, the data transmission device 21 enters the listening state 271 from the sleeping state 275.

In another embodiment of the invention, the reporting counter Cr, the listening counter Cl, and the sleeping counter Cs can be a timer. For example, the data transmission device 21 can also enter the listening state 271 from the sleeping state 275 after a sleeping time slot Ts, predetermined period of time.

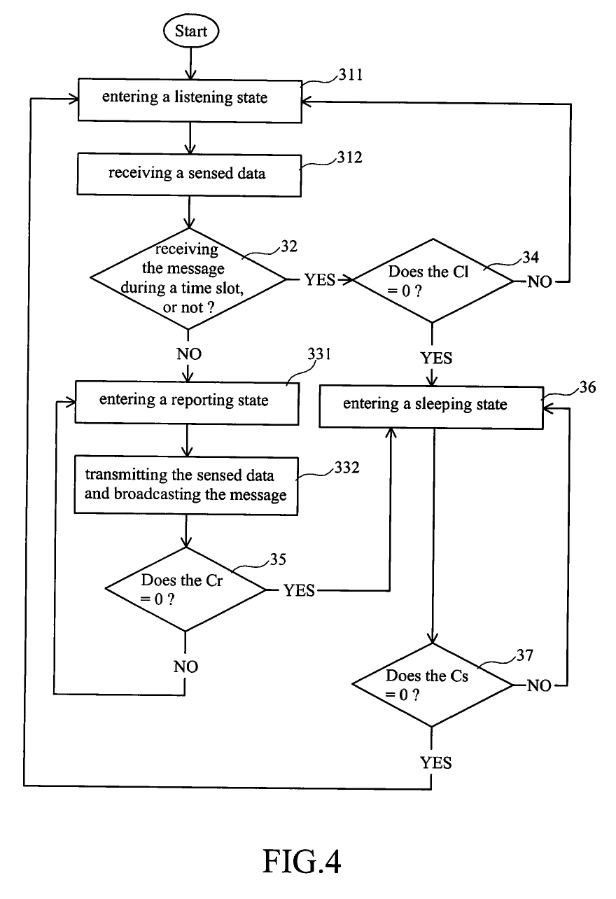

Referring to FIG. 4, a flowchart of the reporting method for the data transmission device according to an embodiment of the present invention is disclosed. Please, refer to FIG. 2 and FIG. 3 at the same time. There is a plurality of data transmission devices 21, and a plurality of sensor devices 23 in the same region 22, and the state of the data transmission device 21 can be changed among the listening state 271, the reporting state 273, and the sleeping state 275.

In one embodiment of the invention, the data transmission device 21, in the sensing region 22, enters the listening state 271, as shown in step 311. The data transmission device 21, at the listening state 271, receives the sensed data 24 from the sensor device 23, as shown in step 312.

Moreover, the data transmission device 21, at the listening state 271, can also receive the message 28 from other data transmission device(s) 21 in the same sensing region 22. The data transmission device 21 enters the reporting state 273 or the sleeping state 275 after determining whether it received the message 28 during a time slot or not, as shown in step 32. If the data transmission device 21 does not receive the message 28 during the time slot, such as the first time slot T1 and the random time slot Tr, it will enter the reporting state 273, as shown in step 331. Thereafter, the data transmission device 21 can transmit the sensed data 24 to the server 25, and broadcast the message 28 to all other data transmission devices 21 in the sensing region 22, as shown in step 332.

In addition, as the data transmission device 21 enters the reporting state 273, the reporting counter Cr can be initialized to count the times of transmitting the sensed data 24. Furthermore, the data transmission device 21 can determine whether the reporting counter Cr is equal to zero or not, as shown in step 35. If the reporting counter Cr is equal to zero, the data transmission device 21 enters the sleeping state 275, as shown in step 36. If the reporting counter Cr is not equal to zero, the data transmission device 21 remains at the listening state 271, as shown in step 331.

Furthermore, if the data transmission device 21 receives the message 28 during a time slot, such as the first time slot T1 and the random time slot Tr, it will determine whether the listening counter Cl is equal to zero or not, as shown in step 34. If the listening counter Cl is equal to zero, the data transmission device 21 enters the sleeping state 275, as shown in step 36. If the listening counter Cl is not equal to zero, the data transmission device 21 remains at the listening state 271, as shown in step 311.

As the data transmission device 21 enters the sleeping state 275, the sleeping counter Cs can be initialized, and the data transmission device 21 can determine whether the sleeping counter Cs is equal to zero or not, as shown in step 37. If the sleeping counter Cs is equal to zero, the data transmission device 21 enters the listening state 271, as shown in step 311. If the sleeping counter Cs is not equal to zero, the data transmission device 21 remains at the sleeping state 275, as shown in step 36.

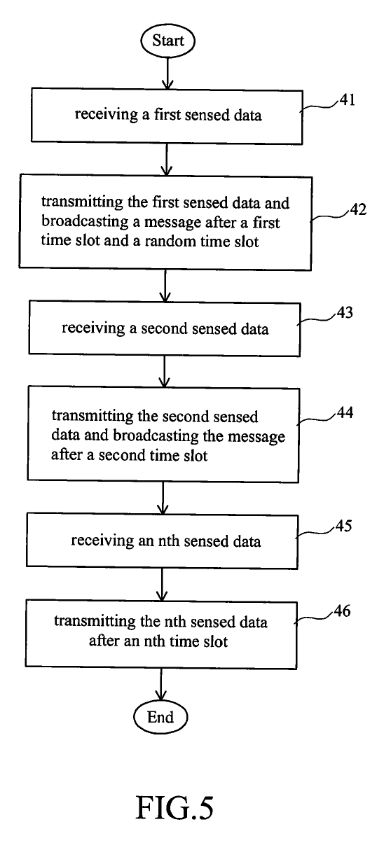

Referring to FIG. 5, a flowchart of the reporting method for the data transmission device according to an embodiment of the present invention is disclosed. Please, refer to FIG. 2, FIG. 3, and FIG. 4 at the same time. The data transmission system 20 comprises a plurality of data transmission devices 21, and the state of the data transmission devices 21 in the sensing region 22 can be changed among the listening state 271, the reporting state 273, and the sleeping state 275.

The data transmission device 21 enters the listening state 271 for receiving a first sensed data 241 from the sensor device 23, as shown in step 41. As the data transmission device 21 does not receive the message 28 from any of the other data transmission devices 21 in the sensing region 22 during the first time slot T1 and the random time slot Tr after receiving the sensed data 24 from the sensor device 23, the data transmission device will transmit the first sensed data 241 to the server 25 and broadcast the message 28, as shown in step 42. The data transmission device 21 receives a second sensed data 243 from the sensor device 23, as shown in step 43. Thereafter, the data transmission device 21 transmits the second sensed data 243 to the server 25 and broadcasts the message 28 after a second time slot T2, as shown in step 44.

The data transmission device 21 receives an nth sensed data 249 from the sensor device 23, wherein the nth sensed data 249 is the last sensed data 24 of this time reporting state 273, as shown in step 45. Thereafter, the data transmission device 21 transmits the nth sensed data 249 to the server 25 after an nth time slot Tn, wherein the reporting counter Cr is equal to zero after transmitting the nth sensed data 249, and the data transmission device 21 does not broadcast the message 28 while transmitting the nth sensed data 249, as shown in step 46. Furthermore, the data transmission device 21 enters a sleeping state 275 after transmitting the nth sensed data 249.

Since the data transmission device 21 does not broadcast the message 28 while transmitting the nth sensed data 249, other data transmission device(s) 21 can transmit the sensed data 24 after the first time slot T1 and the random time slot Tr. For example, there are a first data transmission device 211, a second data transmission device 212, and a third data transmission device 213 in the sensing region 22. As the first data transmission device 211 transmits the first sensed data 241 and the second sensed data 243, the second data transmission device 212 and the third data transmission device 213 will not transmit the sensed data 24 because of their receiving the message 28. However, the first data transmission device 211 does not broadcast the message 28 while transmitting the nth sensed data 249, so the second data transmission device 212 or the third data transmission device 213 will transmit the sensed data 24 to the server 25 after the first time slot T1 and the random time slot Tr.

The first time slot T1, the second time slot T2, and the nth time slot Tn can be the same, such that the sensed data 24 of the sensing region 22 can be transmitted from one of the data transmission devices 21 to the server 25 about the first time slot TI, and the server 25 can obtain the information of the sensing region 22 continuously.

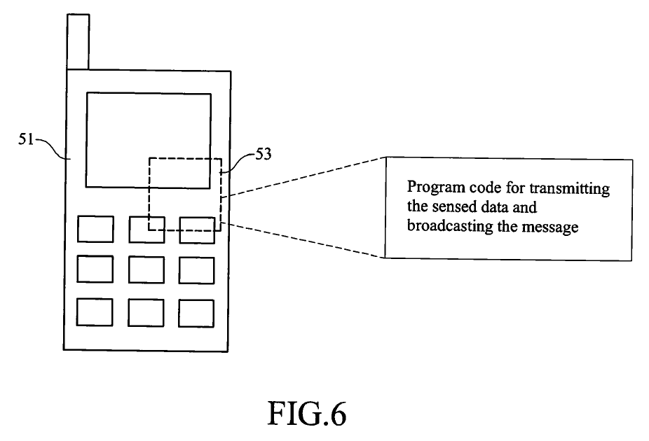

Referring to FIG. 6, a schematic diagram of a computer-readable medium 53 inside a data transmission device 51, such as a storage medium, storing a computer program for execution of a reporting method according to an embodiment of the present invention is disclosed. The computer-readable medium having stored thereon a set of instructions to translate instructions, the set of instructions, which when executed by a processor, cause the processor to perform a method comprising the steps of: receiving a first sensed data; transmitting the first sensed data and broadcasting a message after a first time slot and a random time slot; receiving a second sensed data; transmitting the second sensed data and broadcasting the message after a second time slot; receiving an nth sensed data; and transmitting the nth sensed data after an nth time slot.

Transmitting methods and systems, or certain aspects or portions thereof, may take the form of program code (i.e., executable instructions) embodied in tangible media, such as flash memories, RAMs, floppy diskettes, CD-ROMS, hard drives, or any other machine-readable storage medium, wherein, when the program code is loaded into and executed by a machine, such as a computer or a device comprising a mobile phone, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer or a device comprising a mobile phone, the machine becomes an apparatus for practicing the disclosed methods. When implemented on a general-purpose processor, the program code combines with the processor to provide a unique apparatus that operates analogously to application specific logic circuits.

The above embodiments are only used to illustrate the present invention, and are not intended to limit the scope thereof. Many modifications of the above embodiments can be made without departing from the spirit of the present invention.

What is claimed is:

1. A reporting method for a data transmission device within a sensing region, said sensing region has one or more data transmission devices for receiving a sensed data from a sensor device, transmitting said sensed data to a server, and broadcasting a message, said reporting method comprising the steps of:
entering a listening state for receiving said sensed data from said sensor device;
determining whether a message from another data transmission device is received during a time slot;
entering a reporting state for transmitting said sensed data and broadcasting said message, if the message from another data transmission device is not received;
determining whether a reporting counter equals zero;
remaining at said reporting state, as said reporting counter is not equal to zero; and
entering a sleeping state, as said reporting counter equals to zero.

2. The reporting method of claim 1, further comprising the steps of:
determining whether a listening counter equals to zero, as said data transmission device receives said message from another data transmission device;
entering said sleeping state, as said listening counter equals zero; and
remaining at said listening state, as said listening counter is not equal to zero.

3. The reporting method of claim 2, further comprising the steps of:
determining whether a sleeping counter equals to zero;
remaining at said sleeping state, as said sleeping counter is not equal to zero; and
entering said listening state, as said sleeping counter equals to zero.

4. The reporting method of claim 1, wherein said time slot is a first time slot and a random time slot.

5. The reporting method of claim 1, further comprising the steps of:
determining whether a sleeping counter equals to zero;
remaining at said sleeping state, as said sleeping counter is not equal to zero; and
entering said listening state, as said sleeping counter equals to zero.

6. The reporting method of claim 1, wherein only one of said data transmission devices enters said reporting state in said sensing region at a time.

7. The reporting method of claim 1, wherein said data transmission device is a stationary device or a portable device.

8. The reporting method of claim 1, wherein said data transmission device and said sensor device can be integrated into a data sensing transmission device.

9. The reporting method of claim 1, further comprising the step of receiving said sensed data from said sensor device at said reporting state.

10. A reporting method for a data transmission device within a sensing region, said sensing region has one or more data transmission devices for receiving a sensed data from at least one sensor device, transmitting said sensed data to a server, and broadcasting a message, said reporting method comprising the steps of:
entering a listening state for receiving said sensed data from said sensor device;
entering a reporting state for transmitting said sensed data to said server, and broadcasting said message; and
entering a sleeping state.

11. The reporting method of claim 10, further comprising the step of receiving said message from another data transmission device at said listening state.

12. The reporting method of claim 10, further comprising the step of entering said reporting state from said listening state after a first time slot and a random time slot, as said data transmission device receives said sensed data at the listening state.

13. The reporting method of claim 10, further comprising the step of entering said listening state from said sleeping state after a sleeping time slot.

14. The reporting method of claim 10, further comprising the step of entering said sleeping state from said reporting state after transmitting at least one said sensed data.

15. The reporting method of claim 10, wherein only one of said data transmission devices enters said reporting state in said sensing region at a time.

16. The reporting method of claim 10, wherein said data transmission device is a stationary device or a portable device.

17. The reporting method of claim 10, further comprising the step of receiving said sensed data from said sensor device at said reporting state.

18. A computer-readable medium having stored thereon a set of instructions to translate instructions, the set of instructions, which when executed by a processor, cause the processor to perform a method comprising the steps of:
receiving a first sensed data;
transmitting said first sensed data and broadcasting a message after a first time slot and a random time slot;
receiving a second sensed data;
transmitting said second sensed data and broadcasting said message after a second time slot;
receiving an nth sensed data; and
transmitting said nth sensed data after an nth time slot.

19. The computer-readable medium of claim 18, wherein said data transmission device receives said first sensed data, said second sensed data, and said nth sensed data from at least one sensor device.

20. The computer-readable medium of claim 18, wherein the method further comprising the step of entering a sleeping state after transmitting said nth sensed data.
